(19) United States
(12) Patent Application Publication
(10) Pub. No.: US 2008/0275860 A1
(43) Pub. Date: Nov. 6, 2008

(54) Seamless design

(76) Inventors: Alex Zakonov, Manchester, CT (US); Polina Cherkasova, West Hartford, CT (US)

Correspondence Address: THE LAW OFFICES OF STEVEN MCHUGH, LLC, 46 WASHINGTON STREET, MIDDLETOWN, CT, 06457, US

(21) Appl. No.: 12/151,213

(22) Filed: May 5, 2008

Related U.S. Application Data
(60) Provisional application No. 60/927,623, filed on May 3, 2007.

(51) Int. Cl. G06F 17/30

(52) U.S. Cl. 707/4; 707/E17.014

(57) ABSTRACT

A system and method for facilitating the interaction between a database application and a relational database is provided and includes accepting at least one object method argument in the form of at least one query variable, where the query variable has a database query encapsulated within. The method further includes modifying the query variable to generate a modified query variable and converting the modified query variable from a first type/class to a second type/class to generate a converted modified query variable. The method also includes passing the converted modified query variable through the call stack and modifying the content of the relational database responsive to the converted modified query variable.

This application relates to U.S. Provisional Patent Application Ser. No. 60/927,623 (Atty. Docket No. AVI-0005-P), filed May 3, 2007, the contents of which are incorporated by reference herein in its entirety.

### FIELD OF THE INVENTION

This invention relates generally to database applications and more particularly to the use of Object Oriented Design (OOD) for database applications.

### BACKGROUND OF THE INVENTION

As is well known in the fields of relational databases and object-oriented programming, Object-Relational Mapping, or ORM, is a technique used to convert data between incompatible type systems by creating a ‘virtual object database.’ For example, ORM allows a database record to be represented by an object in the application memory, wherein the application manages and synchronizes the object with the database from time to time. However, the interactions between object-oriented code and relational databases are typically accompanied by a problem that involves a concept known as “Impedance Mismatch,” which occurs due to the differences between the data representation in the object-oriented code and the data representation in the relational data storage. This is because object-oriented code keeps data in the form of an object tree, while the relational data storage represents the data in the form of tables. One current method for addressing this problem involves a special Data Access Level that contains automatically generated entity objects and provides the framework for the loading and synchronization of these objects. An ORM tool used for ORM mapping is then used to convert between object-oriented data and relational data.

Unfortunately however, although the ORM tools successfully solve the problem of abstracting data from object-oriented code, there is a significant downside related to these tools in terms of application performance. This application performance is negatively affected because object-oriented applications deal with data on the level of individual objects and, as a result, process data in the database on the level of individual records, while Relational Database Management Systems (RDBMS) can process large amounts of data very quickly only if the data is represented in the form of relational tables. This problem becomes especially critical when dealing with larges amounts of data and bulk data processing where execution times are important, such as is typical for business to business and data import/export components of an application. As task execution times become unacceptable, application designers are left scrambling to optimize performance without sacrificing the consistency of the application's architecture. As a result, as soon as the application performance reaches a critical level, the ORM rules are typically bypassed and high-performance code is inserted in its place to account for performance.

One approach at solving this problem involves separating responsibilities between classes. For example, consider the following two code fragments:
(1) Detail detail=new Detail (wheelId);
   Order.Add(detail, 1)
(2) foreach (DetailLot lot in car.Parts)
   order.Add(lot.Detail, N* lot.Count).
      As shown, code fragment (1) includes the selected part into the delivery order, while code fragment (2) includes parts for manufacturing N copies of the given product into the order. Unfortunately however, using this approach relational records are retrieved from the database one record at a time and as such instead of performing one SQL query, a separate SQL query must be performed for each part.

This is undesirable because each query requires connecting with and initializing the database, resulting in a very inefficient process flow, a decrease in the performance of the relational database and a waste of system resources. Moreover, attempts to process a set of records using a single query leads to the implementation of the same functionality in several places causing a system redundancy that tends to make the system more complicated and the development and support costs more expensive than necessary.

### SUMMARY OF THE INVENTION

A seamless design method for facilitating the interaction between a database application and a relational database is provided and includes accepting at least one object method argument in the form of at least one query variable, where the query variable has a database query encapsulated within. The method further includes modifying the query variable to generate a modified query variable and converting the modified query variable from a first type/class to a second type/class to generate a converted modified query variable. The method also includes passing the converted modified query variable through the call stack and modifying the content of the relational database responsive to the converted modified query variable.

A system for implementing a seamless design method for facilitating the interaction between a database application and a relational database is provided where the system includes a means for storing a relational database and a means for implementing a database software application associated with the relational database, wherein the database software application is configured to implement the seamless design method which includes accepting an object method argument in the form of a query variable, where the query variable has a database query encapsulated within, modifying the query variable to generate a modified query variable, converting the modified query variable from a first type/class to a second type/class to generate a converted modified query variable, passing the converted modified query variable through the call stack and modifying the content of the relational database responsive to the converted modified query variable.

A computer readable storage medium having computer executable instructions for implementing a seamless design method for facilitating the interaction between a database application and a relational database is provided wherein the method includes accepting an object method argument in the form of a query variable, where the query variable has a database query encapsulated within, modifying the query variable to generate a modified query variable, converting the modified query variable from a first type/class to a second type/class to generate a converted modified query variable, passing the converted modified query variable through the call stack and modifying the content of the relational database responsive to the converted modified query variable.

### BRIEF DESCRIPTION OF DRAWINGS

The foregoing and other features and advantages of the present invention will be better understood from the following detailed description of illustrative embodiments, taken in conjunction with the accompanying drawings in which:

FIG. 1 is a block diagram illustrating the overall seamless design method in accordance with the present invention; and

FIG. 2 is a block diagram illustrating one embodiment of the overall seamless design method of FIG. 1.

### DETAILED DESCRIPTION OF THE INVENTION

In accordance with the present invention, a ‘seamless design method’ of database programming to address the problem of impedance mismatch in relational databases and object-oriented programming is disclosed herein and is discussed in terms of .NET language. However, it is contemplated that any language suitable to the desired end purpose may be used. The invention combines object-oriented programming and relational database technologies in order to take full advantage of object-oriented programming without sacrificing relational performance, wherein this approach relies on the structure of the information system and distribution of responsibilities between the system components. It should be appreciated that this ‘seamless’ style of programming allows for the implementation of data processing techniques in an object oriented manner without sacrificing high-performance power characteristics of relational data storage.

In accordance with the present invention, the seamless application as discussed herein recognizes that the primary information unit used for communication between objects, code blocks and the function/method of the objects is the query variable, where the query variable is an instance of an object that encapsulates a database query in some database query language. Accordingly, the method of the invention involves accepting at least one query variable as an argument via the object method (alternatively the query variable may be created via the method of the invention or obtained from a separate source), modifying the query variable (may or may not be responsive to the database query), converting the modified query variable from one class/type to another (such as from a “NUMBER” type to a “STRING” type) and passing the converted modified query variable further through the call stack. Essentially, because an application defines a set of query classes, where a class corresponds to a type of query object, the query object can be converted from one query class/type to another. Thus, the method of the invention, allows the query variable to be considered as an information unit for passing information about data between objects, code blocks and object methods/functions. This allows an object method argument to be accepted in the form of a query variable (which may include a database query encapsulated within, wherein the query variable may be created via the method or obtained from a storage location), the query variable modified (may or may not be in response to the database query), converted from one class/type to another class/type and passed through the call stack where the contents of the database may be modified helping response to the database query encapsulated in the query variable.

For example, the following software routine fragments update data directly inside the database without loading the data into memory:

```
IQueriable<Order> orders = from o in orders
    where o.OrderStatus = = OrderStatus.Prepared
    select new Order (o) { OrderStatus = OrderStatus.Completed };
dataContext.Orders.Update(orders).
```

Additionally, the method of the present invention provides the ability to develop tasks (such as B2B tasks) in classical object-oriented design fashion, while at the same time allowing for the full use of the power of relational data processing.

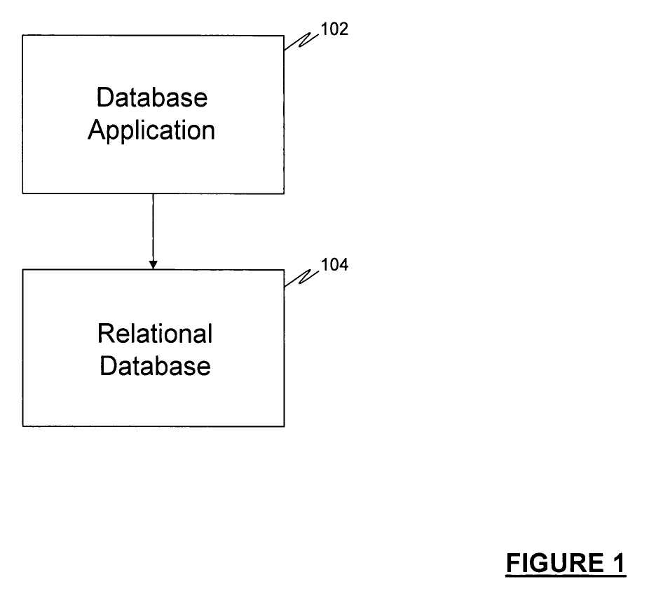

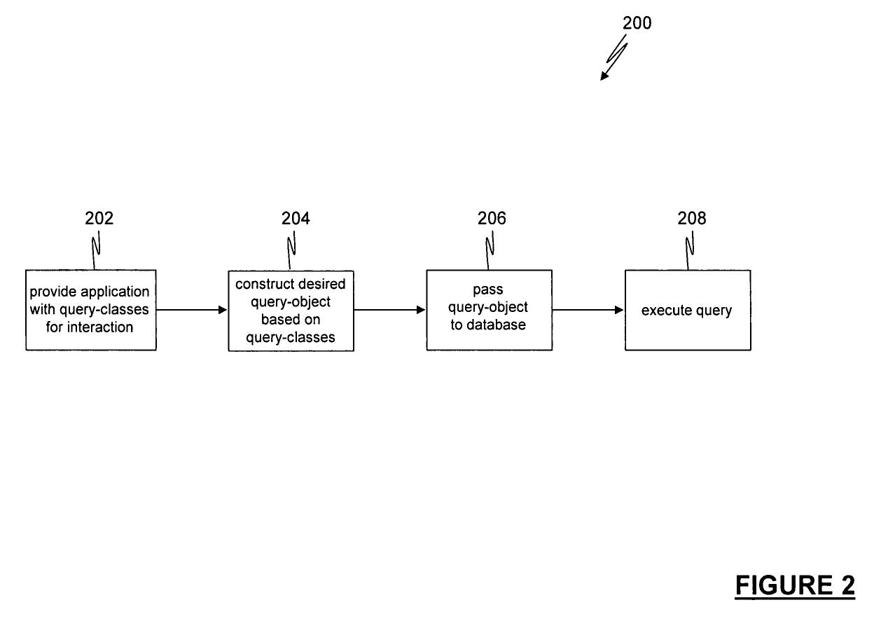

In accordance with the present invention, the method of the invention is discussed herein in terms of database application associated with a relational database. Referring to FIG. 1, consider the situation where there is a database application 102 associated with a relational database 104. In this case, query-classes are created based on the structure of the relational database 104 and inserted into the database application 102. The database application 102 then generates query-objects based on these query-classes and passes these query-objects to the relational database 104 for execution. Query-objects describe a set of records and provides a natural way for objects in the business logic tier to work with sets of data. Referring to FIG. 2, a block diagram illustrating one embodiment of a seamless method 200 is shown in accordance with the present invention and is discussed herein with regards to a software application 102 which interacts with a relational database 104. As shown in operational block 202, the method 200 includes using of a set of predefined query-classes which are generated (or obtained) and based on the structure of the relational database 104. It is contemplated that the set of query-classes may be generated as part of the method 200 or the set of query-classes may be generated outside of and obtained as part of the method 200. The software application 102 then constructs (or obtains) query-objects which are based upon the set of query-classes, as shown in operational block 204, wherein the query-object is typically an interpreter, or structure of objects that is formed into an SQL query. The software application 102 then passes the query-objects to the relational database 104 for execution, as shown in operational block 206. In accordance with the present invention, the passing of query-objects to the relational database 104 may be accomplished using any method suitable to the desired end purpose, such as in the form of an SQL query. Once the query-objects are passed to the relational database 104, the database 104 executes the query, as shown in operational block 208. It should be appreciated that if the query-object is a select-query, the query is typically executed and the result is typically returned to the front-end layer of the software application. On the other hand, if the query-object is a modification-query (i.e. insert, update, delete), then the query is typically executed without exchanging data between the software application 102 and the relational database 104.

In order to aid in understanding and to fully appreciate the method of the present invention, the seamless design method 200 is discussed in terms of an example which compares and shows the contrast between the current method with the seamless design method 200 of the present invention and usual approach, as shown immediately hereinafter. Consider the situation where a web service receives and processes product orders and updates the product items in the store. Accordingly, because the product orders need to be identified or marked as processed and the items in the store need to be updated, two data tables need to be maintained and updated with current information. Example 1 below illustrates current programming methods for accomplishing these tasks and can be represented by the following program code segment (shown in “DLinq and B2B”) which implements these tasks, where the program code segment uses the current programming techniques and does not use the seamless updating method of the present invention. Accordingly, the program code segment may typically look as follows:

### EXAMPLE 1

```
[WebMethod]
public static void ProcessOrders(DateTime from, DateTime to)
{
  IQueriable<Order> orders = GetOrdersForPeriod(from, to);
  ProcessOrders(orders);
}
public static void ProcessOrder(int orderId)
{
  var order = from o in App.Db.Orders
  where o.OrderId == orderId select o;
  ProcessOrders(order);
}
public static void ProcessOrders(IQueriable<Order> orders)
{
  foreach (Order order in orders)
    {
    order.IsProcessed = true;
    order.ProcessingDate = DateTime.Now( );
    foreach (OrderItem orderItem in order.OrderItems)
        orderItem.Item.Count = orderItem.Item.Count −
        orderItem.Count;
    }
  App.Db.ApplyChanges( );
}
```

As can be seen by examining this program code segment, the current methods involve processing the order records and updating the database one by one using separate queries. Depending upon the quantity of the records, it is apparent that this approach is very inefficient and consumes large amounts of time and resources.

However, Example 2 below illustrates the programming methods for accomplishing these tasks using the seamless design method 200 of the present invention and can be represented by the following program code segment (shown in “DLinq and B2B”). For illustration purposes, Example 2 relies on the SeamlessLinq extension (Linq to SQL) for the DLinq library which extends DLinq (and thus allows for relational use) to include support for insert, update and delete queries. Accordingly, the program code segment implementing the seamless design method 200 of the present invention may typically look as follows:

### EXAMPLE 2

```
[WebMethod]
public static void ProcessOrders(DateTime from, DateTime to)
{
  IQueriable<Order> orders = GetOrdersForPeriod(from, to);
  ProcessOrders(orders);
}
public static void ProcessOrder(int orderId)
{
  var order = from from o in App.Db.Orders
  where o.OrderId == orderId select o;
  ProcessOrders(order);
}
public static void ProcessOrders(IQueriable<Order> orders)
{
  IQueriable<Order> processedOrders = from o in orders
    select new Order(o) { IsProcessed = true, ProcessingDate =
    DateTime.Now( ) };
  IQueriable<Item> orderTotal = Items.GetTotal(orders);
  IQueriable<Item> updatedItems = from ot in orderTotal
    from i in App.Db.Items
    where i.ItemId == ot.ItemId
    select new Item(i) {Count = i.Count − ot.Count};
  using (TransactionScope t = App.Db.BeginTransaction( ))
    {
    App.Db.Orders.Update(processedOrders);
    App.Db.Orders.Update(updatedItems);
    t.Commit( );
    }
}
```

In Example 2, the first query variable represents all processed orders with modified values of fields as “IsProcessed” and “ProcessingDate” and the second query variable represents items in the store as “orderTotal=Items.GetTotal(orders).” Thus, the expression contains only those items that take part in the order process, where the count of currently available items may be decreased. Accordingly, the created queries may be sent to the relational database for execution and the entities specified in the queries may be found by ID and updated. As shown above, Example 2 illustrates how (for B2B data processing) according to the method of the present invention, the defined method allows the input data to be accepted in the form of a query, modified responsive to the query, converted to a ‘modified query’, and without mixing these ‘modified queries’ with object-oriented structures, sent to the relational database for execution. It should be appreciated that although the method of the present invention is discussed herein in terms of Dlinq and B2B data processing, this is not meant to be limiting to only those situations and thus any language and implementation suitable to the desired end purpose may be used.

It should be appreciated that even though the program code segment illustrated in Example 1 (i.e. the current method of achieving the desired result) looks cleaner and easier to implement than the program code segment illustrated in Example 2 (i.e. the seamless design method of the present invention), the performance of the program code segment in Example 1 is much worse than the performance of the program code segment in Example 2. Thus, the program code segment illustrated in Example 2 (and hence the seamless design method of the present invention) is far superior to the program code segment in Example 1 (and hence the approach used by current methods). It should also be appreciated that although Example 2 relies on the SeamlessLing extension for the DLing library, the method of the present invention may be practiced using any software and/or software component/extension suitable to the desired end purpose.

Furthermore, it is contemplated that the method 200 of the present invention may be embodied in the form of computer-implemented processes and apparatuses for practicing those processes. Moreover, the method 200 of the present invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) may be updated to implement the invention. The method 200 of the present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments may configure the microprocessor to create specific logic circuits.

Moreover, each of the elements of the present invention may be implemented in part, or in whole, in any order suitable to the desired end purpose. In accordance with an exemplary embodiment, the processing required to practice the method of the present invention, either in whole or in part, may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. It should also be appreciated that the embodiments disclosed herein are for illustrative purposes only and include only some of the possible embodiments contemplated by the present invention.

Furthermore, the invention may be wholly or partially embodied in the form of a computer system or controller implemented processes. It should be appreciated that any type of computer system (as is well known in the art) and/or gaming system may be used and that the invention may be implemented via any type of network setup, including but not limited to a LAN and/or a WAN (wired or wireless). The invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A seamless design method for facilitating the interaction between a database application and a relational database, comprising:
accepting an object method argument in the form of a query variable, where the query variable has a database query encapsulated within;
modifying the query variable to generate a modified query variable;
converting the modified query variable from a first type/class to a second type/class to generate a converted modified query variable;
passing the converted modified query variable through the call stack; and
modifying the content of the relational database responsive to the converted modified query variable.

2. The method of claim 1, wherein said accepting the object method argument includes at least one of creating and obtaining the query variable using a set of predefined query-classes.

3. The method of claim 2, wherein said modifying the query variable includes generating the set of predefined query-classes based on the structure of the relational database.

4. The method of claim 1, wherein said modifying the query variable further includes at least one of generating and obtaining a set of query-classes.

5. The method of claim 4, wherein said modifying the query variable further includes generating query objects responsive to the set of query-classes.

6. The method of claim 1, wherein said modifying the query variable includes constructing query objects responsive to a set of query-classes.

7. The method of claim 1, wherein said modifying the content of the relational database includes passing the converted modified query variable to the relational database in the form of an SQL query.

8. The method of claim 1, further comprising passing the converted modified query variable to the relational database through the call stack in the form of an SQL query.

9. A system for implementing a seamless design method for facilitating the interaction between a database application and a relational database, the system comprising:
a means for storing a relational database;
a means for implementing a database software application associated with the relational database, wherein the database software application is configured to implement the seamless design method comprising,
accepting an object method argument in the form of a query variable, where the query variable has a database query encapsulated within;
modifying the query variable to generate a modified query variable;
converting the modified query variable from a first type/class to a second type/class to generate a converted modified query variable;
passing the converted modified query variable through the call stack; and
modifying the content of the relational database responsive to the converted modified query variable.

10. The system of claim 9, wherein said accepting the object method argument includes at least one of creating and obtaining the query variable using a set of predefined query-classes.

11. The system of claim 10, wherein said modifying the query variable further includes generating the set of predefined query-classes based on the structure of the relational database.

12. The system of claim 9, wherein said modifying the query variable further includes at least one of generating and obtaining a set of query-classes.

13. The system of claim 12, wherein said modifying the query variable further includes generating query objects responsive to the set of query-classes.

14. The system of claim 9, wherein said modifying the query variable includes constructing query objects responsive to a set of query-classes.

15. The system of claim 9, wherein said modifying the content of the relational database includes passing the converted modified query variable to the relational database in the form of an SQL query.

16. The system of claim 9, further comprising passing the converted modified query variable to the relational database through the call stack in the form of an SQL query.

17. A computer readable storage medium having computer executable instructions for implementing a seamless design method for facilitating the interaction between a database application and a relational database, the method comprising:
accepting an object method argument in the form of a query variable, where the query variable has a database query encapsulated within;
modifying the query variable to generate a modified query variable;
converting the modified query variable from a first type/class to a second type/class to generate a converted modified query variable;
passing the converted modified query variable through the call stack; and
modifying the content of the relational database responsive to the converted modified query variable.

18. The computer readable storage medium of claim 17, wherein said accepting the object method argument includes at least one of creating and obtaining the query variable using a set of predefined query-classes.

19. The computer readable storage medium of claim 18, wherein the predefined query-classes are based on the structure of the relational database.

20. The computer readable storage medium of claim 18, further comprising,
constructing query objects responsive to a set of query-classes; and
passing the converted modified query variable to the relational database through the call stack as an SQL query.
